(19) United States
(12) Patent Application Publication
(10) Pub. No.: US 2018/0183597 A1
(43) Pub. Date: Jun. 28, 2018

(54) METHOD FOR THE SECURITY OF AN ELECTRONIC OPERATION WITH A CHIP CARD

(71) Applicants: Rozenn Trubert, Colombes (FR); Nicolas Loiseau, Colombes (FR)

(72) Inventors: Rozenn Trubert, Colombes (FR); Nicolas Loiseau, Colombes (FR)

(73) Assignee: OBERTHUR TECHNOLOGIES, Colombes (FR)

(21) Appl. No.: 15/851,986

(22) Filed: Dec. 22, 2017

(30) Foreign Application Priority Data
Dec. 23, 2016 (FR) 1663307

(51) Int. Cl. H04L 9/32; H04L 9/08

(52) U.S. Cl. CPC H04L 9/3226; G06Q 20/3829; G06Q 2220/00; H04L 9/0894

(57) ABSTRACT

A method for assisting in improving the security of an electronic operation carried out via a chip card. The method comprises comparing a cryptographic nonce received last by the chip card with at least one reference cryptographic nonce stored on the chip card, in order to quantify their degree of similarity by a last similarity data. If the last similarity data or global similarity data coming from the last similarity data satisfies a predefined condition, a countermeasure is taken in order to increase the security of the electronic operation.

### TECHNICAL FIELD

According to a first aspect, this invention relates to a method for assisting in improving the security of an electronic operation with a chip card. According to a second aspect, this invention relates to a chip card comprising first means of computer execution for implementing certain steps of the method. According to a third aspect, the invention proposes a computer program comprising instructions for the execution of the steps of the method. According to a fourth aspect, the invention proposes a recording medium that can be read by means of computer execution and whereon are recorded instructions for the execution of the steps of the method.

### BACKGROUND

It is known to use a chip card in order to carry out an authentication with a reader in order to carry out an electronic operation. For example, such a chip card can be used to authenticate oneself with a security door so that it opens automatically or to authenticate oneself with a payment terminal so that a bank transaction can be carried out.

It is important that the authentication not be able to be falsified. A known method for reducing the risk of falsification of the authentication is as follows. The reader sends a cryptographic nonce to the chip card. The chip card determines, based on the cryptographic nonce and one a key stored in its memory, a securing cryptogram and sends it to the reader. This determination can require the entry of a secret code sometimes called a PIN code. The reader sends the securing cryptogram and the cryptographic nonce to a verification entity, which can be the entity that issued the chip card. The verification entity checks the securing cryptogram by using the cryptographic nonce as a base. If the verification succeeds, the electronic operation can take place. If the verification fails, the electronic operation cannot take place.

The following method can be used to falsify the authentication if it is possible to make conjectures, or predictions, on the cryptographic nonces, in other words, if they are not sufficiently random. This method is sometimes called “replay attack”. A fraudulent reader sends a conjectured cryptographic nonce to an authentic chip card. In response, the authentic chip card sends a conjectured securing cryptogram corresponding to the conjectured cryptographic nonce. The latter is stored by the fraudulent reader.

In what follows, it is possible to store this conjectured securing cryptogram on a fraudulent chip card. This fraudulent chip card can be put into communication with a second reader in order to attempt to carry out an authentication. The second reader sends, as during a normal operation, an authentic cryptographic nonce to the fraudulent chip card. The latter, in response, sends back to it the conjectured securing cryptogram. The conjectured securing cryptogram and the authentic cryptographic nonce are sent to the verification entity by the second reader. If the authentic cryptographic nonce is equal to the conjectured cryptographic nonce, the verification by the verification entity is successful because the conjectured securing cryptogram is indeed the one that is expected by the verification entity as corresponding to the authentic cryptographic nonce. Consequently, the operation can take place although it has not been authorised by the authentic chip card.

It is therefore important to be able to check if the cryptographic nonce is indeed random.

Document WO2016/097650 discloses examples of actions in order to improve the security of electronic operations. However, these actions do not make it possible to check the similarity of cryptographic nonces.

### SUMMARY

The invention has for purpose to improve the security of an electronic operation between a chip card by checking the similarity of cryptographic nonces used for said electronic operation.

To this effect, according to a first aspect, the invention proposes a method for assisting in improving the security of an electronic operation with a chip card, said chip card comprising a memory that stores reference cryptographic nonces, with the method comprising the steps of:

receiving a last cryptographic nonce intended for determining a securing cryptogram for said electronic operation;

determining a last similarity data on the basis of the result of at least one comparison between said cryptographic nonce and one of said reference cryptographic nonces stored in said memory;

storing said last similarity data in said memory;

checking if said last similarity data satisfies a predefined condition; and

taking a countermeasure if said last similarity data satisfies said predefined condition.

During the method according to the invention, the cryptographic nonce of the electronic operation in progress, called the last cryptographic nonce, is compared with at least one reference cryptographic nonce. Their similarity is quantified by the last similarity data. The quality of the last similarity data is judged by checking if it satisfies a predefined condition and a security countermeasure is implemented if the quality of the last similarity data is poor, in other words if the cryptographic nonce of the electronic operation in progress is too close to a reference cryptographic nonce.

It is therefore possible to act, via the countermeasure, on the electronic operation if the cryptographic nonce appears hardly random.

The method according to the invention can be used to improve the security of any electronic operation that makes use of a determination of a securing cryptogram based on a cryptographic nonce. This can for example be used for an electronic operation relating to the opening of a security door or to a bank payment.

The chip card, also called microcircuit card comprises first means of computer execution. It is preferably compliant with the ISO7816 standard. It can, for example, operate according to the EMV (Europay Mastercard Visa) protocol which is an international standard security protocol for payment cards. The EMV protocol makes it possible to reduce the risks of fraud by allowing in particular the authentication of the chip card and of the bearer thereof. The chip card is preferably designed to communicate with an external electronic device called a terminal or reader. The chip card is a portable electronic device.

The memory of the chip card is preferably a non-volatile memory, for example an EEPROM memory. The memory of the chip card is preferably secured. Storage in the memory can be short term or long term.

In the framework of this document, a “securing cryptogram” is a piece of data resulting from an encryption using the cryptographic nonce and potentially other data, for example a key stored in the memory of the chip card. The securing cryptogram can also be called encrypted information encrypted key or encrypted information.

In the framework of this document, a “cryptographic nonce” is a piece of supposedly random data used to generate the securing cryptogram. The cryptographic nonce can also be called random, cryptographic number or cryptographic seed.

In the framework of this document, an “electronic operation”, which can also be called “electronic transaction” comprises a plurality of steps implemented by one or several electronic devices, of which a step of authentication using a cryptographic nonce and a securing cryptogram.

Preferably, the steps (a) to (e) follow each other chronologically. In particular, the steps (a) to (e) follow each other preferably in a relatively short lapse of time, within a maximum of a few minutes.

Preferably, the steps (a) to (c) are carried out by the chip card. More preferably, the steps (a) to (e) are carried out by the chip card.

Preferably, the method according to the invention further comprises a storing of information characteristic of the electronic operation which makes it possible to identify said electronic operation. This can be, for example, an ATC (Application Transaction Counter) of said electronic operation.

According to an embodiment of the invention, the method further comprises a storing of said last cryptographic nonce in said memory. This makes it possible for the last cryptographic nonce to become a reference cryptographic nonce for subsequent electronic operations.

According to an embodiment of the invention, at least one of the reference cryptographic nonces is a cryptographic nonce received during an electronic operation prior to said electronic operation. The method according to the invention then compares cryptographic nonces of several electronic operations. If the latter are similar, this is an indication of a lack of random nature of the cryptographic nonces.

According to an embodiment of the invention, at least one of the reference cryptographic nonces is fixed. For example, one of the reference cryptographic nonces can be 00 00 00 00 and/or FF FF FF FF. This makes it possible to carry out the method according to the invention even if the chip card does not have in memory any cryptographic nonce received during a prior electronic operation.

According to an embodiment of the invention, the method further comprises a sending of information to a verification entity. The verification entity typically has more calculating capacity and programming flexibility than the chip card. The sending of information to the verification entity is done more preferably via a reader connected to the chip card. For example, a portion or all of the step (d) can be carried out by the verification entity. It is then necessary to send the last similarity data or information coming from the latter to the verification entity. It is also possible that it is the verification entity and/or the chip card that carried out the step (e). It is for example possible that the countermeasure of the step (e) understands that the verification entity is forcing the electronic operation to take place online.

According to an embodiment of the invention, the chip card carries out all of the step (d).

According to an embodiment of the invention, the chip card carries out all of the step (e).

According to an embodiment of the invention, the countermeasure of the step (e) understands that the chip card is forcing the electronic operation to take place online.

According to an embodiment of the invention, the step (b) comprises:

comparing said last cryptographic nonce with a first reference cryptographic nonce in such a way as to obtain a first intermediate similarity data;

comparing said last cryptographic nonce with a second reference cryptographic nonce in such a way as to obtain a second intermediate similarity data; and

comparing said first and second intermediate similarity data in such a way as to choose from it the last similarity data.

This makes it possible to quantify the similarity between the last cryptographic nonce and a plurality of reference cryptographic nonces by intermediate similarity data and then to choose the intermediate similarity data that corresponds to the greatest similarity with the last cryptographic nonce.

According to an embodiment of the invention, the last cryptographic nonce comprises first elements located at positions in the last cryptographic nonce, the reference cryptographic nonce comprises second elements located at positions in the reference cryptographic nonce, with each position in the last cryptographic nonce having an equivalent position in the reference cryptographic nonce and the comparison comprises comparing each first element with the second element located in the equivalent position, with an element able to be for example a byte, a nibble or a bit. For example, the first byte of the last cryptographic nonce can be compared to the first byte of the reference cryptographic nonce, the second byte of the last cryptographic nonce can be compared to the second byte of the reference cryptographic nonce and so on for all of the bytes.

According to an embodiment of the invention, the step (d) comprises comparing the last similarity data and a preceding global similarity data stored in said memory during a preceding carrying out of said method in order to determine a last global similarity data. This substep of the step of verification (d) makes it possible to determine similarity data, called global similarity data, which corresponds to the greatest similarity among several electronic operations that have taken place. It is preferably carried out by the chip card during each electronic operation. The global similarity data makes it possible to summarise into a single piece of data the random nature of a plurality of cryptographic nonces received by the chip card. If the verification entity wishes to check the random nature of this plurality of cryptographic nonces received by the chip card, it is sufficient for it to request the global similarity data from the chip card.

According to an embodiment of the invention, said countermeasure prevents the continuation of said electronic operation. As such, if the random nature of the cryptographic nonce is doubtful, the electronic operation cannot be completed. For example, if the electronic operation relates to a payment, the latter cannot take place. However, if the electronic operation concerns the opening of a door, the latter remains closed.

According to an embodiment of the invention, said electronic operation is compliant with the EMV protocol. This protocol is used for a payment operation by the chip card.

According to an embodiment of the invention, said last cryptographic nonce is arranged in order to allow the chip card, based on a key stored in said memory, to determine a securing cryptogram.

According to an embodiment of the invention, the method comprises, if said last similarity data does not satisfy said predefined condition, determining a securing cryptogram based on said last cryptographic nonce and on said key and sending said securing cryptogram to a verification entity. If said last similarity data does not satisfy said predefined condition, it is considered that the cryptographic nonce is sufficiently random. The electronic operation can therefore continue normally, without countermeasure, which includes the calculation of the securing cryptogram by the chip card and the optional sending thereof, via the reader, to the verification entity. This sending can be deferred, for example during an electronic operation offline.

According to a second aspect, the invention proposes a chip card comprising first computer execution means for implementing the steps (a) to (c) of the method according to the invention, more preferably for implementing the steps (a) to (e) of the method as claimed in any preceding claim. It is particularly advantageous that the chip card carry out the steps (a) to (e) because the latter can take place even when there is no connection between the chip card and the verification entity.

The invention furthermore proposes a computer system comprising the chip card and second computer execution means for implementing the steps (d) and (e). The second computer execution means can be included in the chip card or outside of the chip card or be partially included in the chip card and partially outside of the chip card. For example, the second computer execution means can be included, at least partially, in a verification entity included in the computer system.

According to a third aspect, the invention proposes a computer program comprising instructions for the execution of the steps of the method according to the invention when said computer program is executed by computer execution means. These computer execution means are at least partially included in the chip card.

According to a fourth aspect, the invention proposes a recording medium that can be read by computer execution means and whereon are recorded instructions for the execution of the steps of the method according to the invention. The recording medium can include a plurality of memories. Preferably, at least one memory of said plurality is included on the chip card and at least one memory of said plurality is included in the verification entity.

### DESCRIPTION OF THE DRAWINGS

The foregoing aspects and many of the attendant advantages of the claimed subject matter will become more readily appreciated as the same become better understood by reference to the following detailed description, when taken in conjunction with the accompanying drawings, wherein:

FIG. 1 shows a computer system for the implementing of the invention;

FIG. 2 shows a method according to an embodiment of the invention;

FIG. 3 shows an example of a database according to an embodiment of the invention;

FIG. 4 shows an example of determining the last similarity data according to an embodiment of the invention;

FIGS. 5a, 5b, and 5c show various ways of carrying out a comparison between a last cryptographic nonce and a reference cryptographic nonce; and

FIG. 6 shows a first portion of the steps of a verification of a predefined condition according to an embodiment of the invention.

### DETAILED DESCRIPTION

The detailed description set forth below in connection with the appended drawing, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the claimed subject matter to the precise forms disclosed.

This invention is described with particular embodiments and with reference to figures but the invention is not limited by the latter. The drawings or figures described are only diagrams and are not limiting.

In the context of this document, the terms “first”, “second” or “last” are used only to differentiate the various elements and do not imply any order between these elements.

In the figures, identical or similar elements can bear the same references.

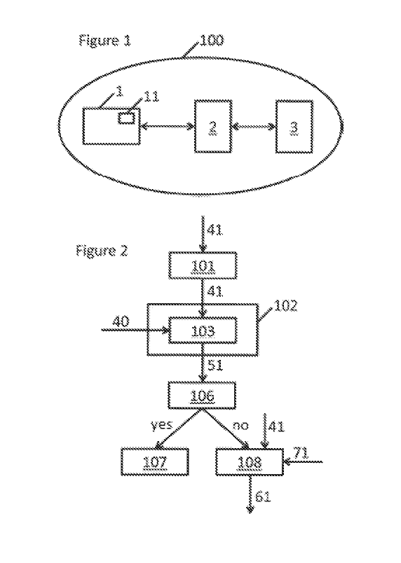

FIG. 1 shows a computer system 100 for the implementing of the invention. The computer system comprises a chip card 1 in electronic communication with a reader 2, itself in electronic communication with a verification entity 3. The chip card 1 comprises a memory 11.

When the chip card 1 is connected to the reader 2 to carry out an electronic operation, the latter can take place online or offline. If it takes place online, this means that the reader 2 is in communication with the verification entity 3 when the chip card 1 is in communication with the reader 2. As such, a securing cryptogram and a cryptographic nonce can be sent directly to the verification entity 3. The verification entity 3 can directly verify the securing cryptogram by using the cryptographic nonce as a base and if the verification is successful, the verification entity 3 can authorise the electronic operation. If the electronic operation takes place offline, the reader 2 itself applies determined verification criteria in order to decide if the electronic operation in progress is authorised. An electronic operation online is therefore more secure than an electronic operation offline.

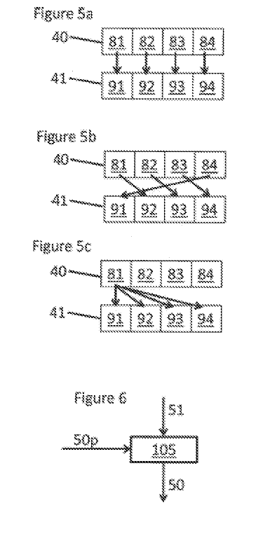

FIG. 2 shows a method according to an embodiment of the invention. The method makes it possible to improve the security of an electronic operation. According to an embodiment of the invention, the method comprises the sending by the reader 2, to the chip card 1, of a last cryptographic nonce 41. The chip card 1 receives 101 the last cryptographic nonce 41. Preferably, the chip card 1 stores the last cryptographic nonce 41 in its memory 11. The chip card 1 uses the last cryptographic nonce 41 and a cryptographic nonce 40 stored in its memory 11 in order to carry out a comparison 103 in order to determine 102 a last similarity data 51. An embodiment of the step of determining 102 is described in more detail in reference to FIG. 4. The last similarity data 51 is preferably stored in the memory 11. The computer system 100 checks 106 if the last similarity data 51 satisfies a predefined condition. Embodiments of the step of verifying 106 are described in more detail hereinafter, in particular in reference to FIG. 6.

If the last similarity data 51 does not satisfy the predefined condition (no), the electronic operation continues. This includes in particular that the chip card 1 uses the last cryptographic nonce 41 and a key 71 stored in its memory 11 in order to determine a securing cryptogram 61. The chip card 1 then sends the securing cryptogram 61 to the reader 2. Afterwards, the reader 2 sends the securing cryptogram 61 to the verification entity 3.

If the last similarity data 51 satisfies the predefined condition (yes), the computer system 100 takes 107 a countermeasure. The countermeasure can be, for example, that the electronic operation has to be carried out online. The countermeasure can be, for example, that the electronic operation is refused, which prevents the following steps of the electronic operation. The countermeasure can be, for example, that the currently executed application and relative to the electronic operation is blocked. In this case, only a specific command can unblock the application. The countermeasure can be, for example, that all contactless electronic operations between the reader 2 and the chip card 1 become prohibited, only electronic operations with contact remain authorised. The countermeasure can be, for example, to block the chip card 1 reversibly or irreversibly. The countermeasure can be, for example, to erase the memory 11 of the chip card 1. If the verification 106 is at least partially carried out by the verification entity 3, the countermeasure 107 comprises, preferably, the sending of information from the verification entity 3 to the chip card 1.

Preferably, the countermeasure 107 can be configured in the customisation phase.

In an embodiment of the invention, the verification 106 is carried out by the chip card 1. Preferably, in such a case, the countermeasure 107 can be configured in the customisation phase.

In an embodiment of the invention, the verification and the countermeasure 107 are implemented by the chip card 1. Preferably, in such a case, the countermeasure 107 can be configured in the customisation phase.

In an embodiment of the invention, the predefined condition is that last similarity data 51 is below a certain threshold or is above a certain threshold.

In an embodiment of the invention, the predefined condition is that resulting data determined from the last similarity data 51 is below a certain threshold or is above a certain threshold.

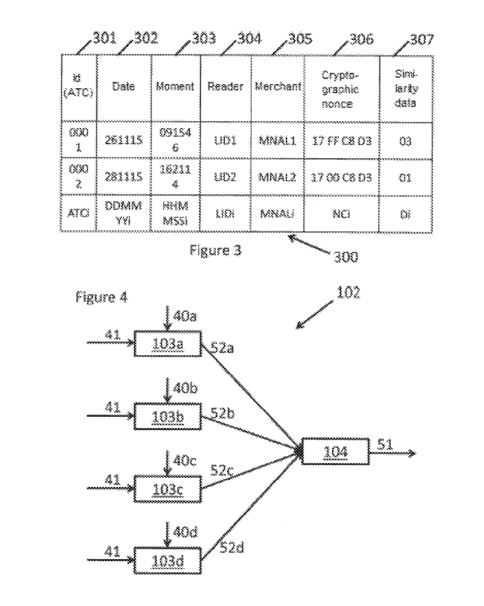

FIG. 3 shows an example of a database 300 stored in the memory 11 of the chip card 1. Preferably, during the method according to the invention, the chip card 1 stores the following information in the database 300: an identifier of the electronic operation, column 301, the date of the electronic operation, column 302, the moment of the electronic operation, column 303, an identifier of the reader 2 whereon the electronic operation is carried out, column 304, an identifier of the merchant corresponding to the reader 2, column 305, the last cryptographic nonce 41, column 306, and the last similarity data 51, column 307. Preferably, a row or a column of the database 300 corresponds to an electronic operation. In an embodiment of the invention, the database 300 comprises a fixed number of lines, with each row corresponding to an electronic operation, and when all of the rows are filled, the oldest row is overwritten by the storage of information for a new electronic operation. The identifier of the electronic operation, column 301, is preferably an ATC number. If there is no fraud with the chip card 1, the ATC numbers of the various electronic operations are supposed to be consecutive.

In an embodiment of the invention, the database 300 comprises eight rows in such a way as to store information relating to eight electronic operations. It is possible to define a criterion for the last similarity data 51 in such a way that only the electronic operations of which the last similarity data 51 corresponds to this criterion, i.e. the most doubtful electronic operations, have information stored in the database 300. In the framework of the EMV protocol, the number of rows of the database 300 and possibly the criterion can be configured in the customisation phase via an EMV command and a proprietary DGI.

FIG. 4 shows an example of determining 102 the last similarity data 51. In this example, determining 102 the last similarity data 51 comprises four comparisons 103a, 103b, 103c, 103d between the last cryptographic nonce 41 and one of the reference cryptographic nonces 40a, 40b, 40c, 40d. Any number of comparisons 103 could be carried out while still remaining within the scope of the invention.

During a first comparison 103a, the last cryptographic nonce 41 is compared to a first reference cryptographic nonce 40a. This results in a first intermediate similarity data 52a. During a second comparison 103b, the last cryptographic nonce 41 is compared to a second reference cryptographic nonce 40b. This results in a second intermediate similarity data 52b. During a third comparison 103c, the last cryptographic nonce 41 is compared to a third reference cryptographic nonce 40c. This results in a third intermediate similarity data 52c. During a fourth comparison 103d, the last cryptographic nonce 41 is compared to a fourth reference cryptographic nonce 40d. This results in a fourth intermediate similarity data 52d.

The intermediate similarity data 52a, 52b, 52c, 52d are then compared 104 and the one that corresponds to the greatest similarity between any of the reference cryptographic nonces 40a, 40b, 40c, 40d and the last cryptographic nonce 41 is chosen to be the last similarity data 51.

In an embodiment of the invention, the first reference cryptographic nonce 40a is a fixed piece of data, for example a fixed number. It can be 00 00 00 00 for example.

In an embodiment of the invention, the second reference cryptographic nonce 40b is a fixed piece of data, for example a fixed number. It can be FF FF FF FF for example.

In an embodiment of the invention, the third reference cryptographic nonce 40c is a cryptographic nonce received during a prior electronic operation. To use the example shown in FIG. 3, it can be equal to 17 FF C8 D3.

In an embodiment of the invention, the fourth reference cryptographic nonce 40d is a cryptographic nonce received during another prior electronic operation. To use the example shown in FIG. 3, it can be equal to 17 00 C8 D3.

FIGS. 5a to 5c show various ways of carrying out the comparison 103. In these illustrations, the last cryptographic nonce 41 comprises first bytes located at positions 91, 92, 93, 94 and the reference cryptographic nonce 40 comprises second bytes located at positions 81, 82, 83, 84. It is clear for those skilled in the art that the position 91 of the last cryptographic nonce 41 is equivalent to the position 81 of the reference cryptographic nonce 40, the position 92 of the last cryptographic nonce 41 is equivalent to the position 82 of the reference cryptographic nonce 40, the position 93 of the last cryptographic nonce 41 is equivalent to the position 83 of the reference cryptographic nonce 40 and the position 94 of the last cryptographic nonce 41 is equivalent to the position 84 of the reference cryptographic nonce 40.

It is possible, while still remaining within the scope of the invention, to carry out the comparison 103 in a similar manner if the elements of the cryptographic nonces 40, 41 are nibbles, bits etc. and regardless of the number of these elements.

FIG. 5a shows a first way to carry out the comparison 103. The similarity data 51 (or intermediate similarity data 52 if several comparisons 103 are carried out as shown in FIG. 4) for this comparison 103 is initially equal to zero. The byte located at the position 81 of the reference cryptographic nonce 40 is compared to the byte located at the position 91 of the last cryptographic nonce 41. If these bytes are different, one is added to the similarity data 51. If they are equal, nothing is added to the similarity data 51.

The byte located at the position 82 of the reference cryptographic nonce 40 is compared to the byte located at the position 92 of the last cryptographic nonce 41. If these bytes are different, one is added to the similarity data 51. If they are equal, nothing is added to the similarity data 51.

The byte located at the position 83 of the reference cryptographic nonce 40 is compared to the byte located at the position 93 of the last cryptographic nonce 41. If these bytes are different, one is added to the similarity data 51. If they are equal, nothing is added to the similarity data 51.

The byte located at the position 84 of the reference cryptographic nonce 40 is compared to the byte located at the position 94 of the last cryptographic nonce 41. If these bytes are different, one is added to the similarity data 51. If they are equal, nothing is added to the similarity data 51.

In summary, if the four bytes are different, the similarity data 51 (or intermediate similarity data 52) for this comparison 103 is equal to four; and if the four bytes are equal, the similarity data 51 (or intermediate similarity data 52) for this comparison 103 is equal to zero. For example, if the last cryptographic nonce 41 is 17 00 C8 D3 and the reference cryptographic nonce 40 is 17 FF C8 D3, the similarity data 51 (or intermediate similarity data 52) is equal to one.

FIG. 5b shows a second way to carry out the comparison 103. It is similar to the first way described in reference to FIG. 5a, except that each byte is compared to the byte offset by one position in the other cryptographic nonce. The resulting similarity data 51 (or intermediate similarity data 52) will be equal to zero, one, two, three or four.

FIG. 5c shows a third way to carry out the comparison 103. The similarity data 51 (or intermediate similarity data 52) for this comparison 103 is initialised to zero. Each byte of the reference cryptographic nonce 40 is compared to each one of the bytes of the last cryptographic nonce 41. If they are different, the similarity data 51 (or intermediate similarity data 52) for this comparison 103 is incremented by one. The resulting similarity data 51 (or intermediate similarity data 52) will be an integer between zero and sixteen.

Generally, regardless of the way in which the comparison 103 is carried out, the similarity data 51 is preferably determined using the number of different elements between the last cryptographic nonce 41 and the reference cryptographic nonce 40 to which it is compared.

In an embodiment of the invention, the verification 106 comprises a first portion carried out by the chip card 1 and shown in FIG. 6 and a second portion carried out by the chip card 1 or by the verification entity 3.

During this first portion of the verification 106, a global similarity data 50 is determined in the following way. The global similarity data 50 is preferably the worst similarity data obtained during all of the determinations 102. The last similarity data 51 is compared 105 with a global similarity data 50p of a preceding electronic operation that was stored in the memory 11. This global similarity data 50p of a preceding electronic operation can be called preceding global similarity data. The global similarity data 50 is chosen between the last similarity data 51 and the preceding global similarity data 50p based on a determined global criterion. This global similarity data 50 chosen can be called “last global similarity data”. Preferably, the one which is chosen is the one that corresponds to the greatest degree of similarity. For example, the smallest of the last similarity data 51 and the preceding global similarity data 50p is chosen. Preferably, the information of the database 300 concerning the electronic operation which corresponds to the global similarity data 50 chosen in stored in order to be able to be read easily. As such, according to this example, the verification 106 can include determining if the min (the preceding global similarity data 50p; the last similarity data 51)<threshold, which is a way of checking if the last similarity data satisfies the predefined condition.

In a first embodiment of the invention, the verification 106 is carried out by the chip card 1 and the taking of the countermeasure 107 is carried out by the chip card 1. Preferably, it is furthermore possible, that the verification entity 3 request the last similarity data 51 from the chip card 1, for example via a read record command or requests the last global similarity data 50 from the chip card 1, for example via a get data command. For example, the verification entity 3 can make this request if the ATC numbers that it has received are not consecutive. The verification entity 3 can then process the similarity data received and possibly decide to take a second countermeasure.

In a second embodiment of the invention, the verification 106 comprises the following steps. The verification entity 3 requests the last similarity data 51 à the chip card 1, for example via a read record command or, if the steps shown in FIG. 6 have been carried out, requests the last global similarity data 50 from the chip card 1, for example via a get data command. For example, the verification entity 3 can make this request if the ATC numbers that it has received are not consecutive. The chip card 1 sends the requested data to the verification entity 3. The verification entity 3 proceeds with a checking on the data received. If yes the predefined condition is satisfied, for example, if the last similarity data 51 is equal to one then the comparison shown in FIG. 5a has been used, the verification entity 3 takes the countermeasure 107.

Generally, if the chip card 1 receives a “get data” command from the verification entity 3, at least one portion of the information contained in the database 300 can be sent to the verification entity 3 so that the fraudulent reader and/or the fraudulent merchant can be determined.

In other terms, the invention relates to a method for assisting in improving the security of an electronic operation carried out via a chip card 1. The method comprises comparing 103 a cryptographic nonce 41 received last by the chip card 1 with at least one reference cryptographic nonce 40 stored on the chip card 1, in order to quantify their degree of similarity by a last similarity data 51. If the last similarity data 51 or global similarity data 50 coming from the last similarity data 51 satisfies a predefined condition, a countermeasure 107 is taken in order to increase the security of the electronic operation.

This invention has been described in relation with specific embodiments, which have a purely illustrative value and must not be considered as being limiting. Generally, this invention is not limited to the examples shown and/or described hereinabove. The use of the verbs “comprise” or “include” or any other alternative, as well as the conjugations thereof, cannot in any way exclude the presence of elements other than those mentioned. Use of the indefinite article “a” or “an”, or of the definite article “the”, for introducing an element does not exclude the presence of a plurality of these elements. The reference numbers in the claims do not limit their scope.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure, as claimed.

The embodiments of the invention in which an exclusive property or privilege is claimed are defined as follows:

1. A method for assisting in improving the security of an electronic operation with a chip card, said chip card comprising a memory that stores reference cryptographic nonces, with the method comprising the steps of:
(a) receiving a last cryptographic nonce intended for determining a securing cryptogram for said electronic operation;
(b) determining a last similarity data on the basis of the result of at least one comparison between said cryptographic nonce and one of said reference cryptographic nonces stored in said memory;
(c) storing said last similarity data in said memory;
(d) checking if said last similarity data satisfies a predefined condition; and
(e) taking a countermeasure if said last similarity data satisfies said predefined condition.

2. The method according to claim 1, further comprising storing said last cryptographic nonce in said memory.

3. The method according to claim 2, wherein at least one of the reference cryptographic nonces is a cryptographic nonce received during an electronic operation prior to said electronic operation.

4. The method according to claim 1, wherein at least one of the reference cryptographic nonces is fixed.

5. The method according to claim 1, further comprising a sending of information to a verification entity.

6. The method according to claim 1, wherein the step (b) comprises:
comparing said last cryptographic nonce with a first reference cryptographic nonce in such a way as to obtain a first intermediate similarity data;
comparing said last cryptographic nonce with a second reference cryptographic nonce in such a way as to obtain a second intermediate similarity data; and
comparing said first and second intermediate similarity data in such a way as to choose from it the last similarity data.

7. The method according to claim 1, wherein the last cryptographic nonce comprises first elements located at positions in the last cryptographic nonce, the reference cryptographic nonce comprises second elements located at positions in the reference cryptographic nonce, with each position in the last cryptographic nonce having an equivalent position in the reference cryptographic nonce and the comparison comprises comparing each first element with the second element located in the equivalent position.

8. The method according to claim 7, wherein an element is a byte, a nibble, or a bit.

9. The method according to claim 1, wherein the step (d) comprises comparing the last similarity data and a preceding global similarity data stored in said memory during a preceding carrying out of said method in order to determine a last global similarity data.

10. The method according to claim 1, wherein said countermeasure prevents the continuation of said electronic operation.

11. The method according to claim 1, wherein said electronic operation is compliant with the EMV protocol.

12. The method according to claim 1, comprising, if said last similarity data does not satisfy said predefined condition, determining a securing cryptogram based on said last cryptographic nonce and on said key and sending said securing cryptogram to a verification entity.

13. A computer system for assisting in improving the security of an electronic operation, the system comprising:
a chip card comprising a memory that stores reference cryptographic nonces and first computer execution means configured to:
receive a last cryptographic nonce intended for determining a securing cryptogram for said electronic operation;
determine a last similarity data on the basis of the result of at least one comparison between said cryptographic nonce and one of said reference cryptographic nonces stored in said memory; and
store said last similarity data in said memory.

14. The computer system according to claim 13, further comprising second computer execution means configured to:
check if said last similarity data satisfies a predefined condition; and
take a countermeasure if said last similarity data satisifies said predefined condition.

15. A non-transitory computer-readable medium having computer-executable instructions stored thereon that, in response to execution by one or more processors of a computing device, cause the computing device to assist in improving the security of an electronic operation with a chip card, said chip card comprising a memory that stores reference cryptographic nonces, by:
(a) receiving a last cryptographic nonce intended for determining a securing cryptogram for said electronic operation;
(b) determining a last similarity data on the basis of the result of at least one comparison between said cryptographic nonce and one of said reference cryptographic nonces stored in said memory;
(c) storing said last similarity data in said memory;
(d) checking if said last similarity data satisfies a predefined condition; and
(e) taking a countermeasure if said last similarity data satisfies said predefined condition.
